(19) United States
(12) Patent Application Publication
(10) Pub. No.: US 2015/0312470 A1
(43) Pub. Date: Oct. 29, 2015

(54) IMAGE PICKUP APPARATUS, IMAGE PICKUP SYSTEM, IMAGE PICKUP METHOD, AND RECORDING MEDIUM

(71) Applicant: CANON KABUSHIKI KAISHA, Tokyo (JP)

(72) Inventor: Tomoaki Kawakami, Utsunomiya-shi (JP)

(21) Appl. No.: 14/684,572

(22) Filed: Apr. 13, 2015

(30) Foreign Application Priority Data
Apr. 25, 2014 (JP) 2014-091221

(51) Int. Cl. H04N 5/232

(52) U.S. Cl. CPC H04N 5/23212

(57) ABSTRACT

An image pickup apparatus includes an imaging optical system configured to form an image of an object, an image pickup unit configured to capture the image of the object via the imaging optical system, and a controller configured to control the image pickup unit. The controller sets, so as to always include part of the object in a first image pickup area corresponding to an image pickup plane of the image pickup unit, a second image pickup area by arranging at least one first image pickup area so that the second image pickup area contains an entire object on each of a plurality of sections perpendicular to an optical axis of the imaging optical system, and controls the image pickup unit so as to capture the first image pickup area that contains an in-focus range of the object in the second image area.

### BACKGROUND OF THE INVENTION

1. Field of the Invention

The present invention relates to an image pickup apparatus, an image pickup system, an image pickup method, and a recording medium.

2. Description of the Related Art

Japanese Patent Domestic Publication No. 2008-510201 discloses an image pickup apparatus configured to capture an image of a sample magnified 5 to 40 times and to connect captured images into one sample image, thereby digitizing shape information from an entire specimen to a cellular tissue and displaying a magnified/reduced image on a monitor. Japanese Patent Laid-Open No. 2009-3016 discloses a method for shortening a sample image generation time by using a lens having a wide angle of view and a plurality of image sensors to reduce the image pickup number. Japanese Patent Laid-Open No. 2004-191959 discloses a method for connecting in-focus images through focusing for each image pickup.

However, all of above references cannot obtain information on the sample image at a position that shifts from the focus position. A pathologist may need to observe a defocus state of a sample for diagnosis by moving the sample in the optical axis direction. Assume that sample images are obtained at a plurality of focus positions in order to obtain images as a result of that the sample is moved in the optical axis direction. Then, a data amount to be stored increases, an acquisition time becomes longer, a display load becomes harder, and the smooth diagnosis is prevented.

### SUMMARY OF THE INVENTION

The present invention provides an image pickup apparatus configured to quickly obtain image data of an object with a small data amount at a plurality of focus position.

An image pickup apparatus according to the present invention includes an imaging optical system configured to form an image of an object, an image pickup unit configured to capture the image of the object via the imaging optical system, and a controller configured to control the image pickup unit. The controller sets, so as to always include part of the object in a first image pickup area corresponding to an image pickup plane of the image pickup unit, a second image pickup area by arranging at least one first image pickup area so that the second image pickup area contains an entire object on each of a plurality of sections perpendicular to an optical axis of the imaging optical system, and controls the image pickup unit so as to capture the first image pickup area that contains an in-focus range of the object in the second image area.

Further features of the present invention will become apparent from the following description of exemplary embodiments with reference to the attached drawings.

### BRIEF DESCRIPTION OF THE DRAWINGS

FIG. 1 is an optical path diagram of an image pickup system according to a first embodiment of the present invention.

FIG. 2 is a flowchart of an image pickup method executed by a computer illustrated in FIG. 1 according to a first embodiment.

FIGS. 3A to 3F are views for explaining a method for correcting a shift associated with driving of a stage in S12 illustrated in FIG. 2 according to the first embodiment.

FIGS. 4A and 4B are views of heights of the stage illustrated in FIG. 1 according to the first embodiment.

FIGS. 5A and 5B are a schematic sectional view of a sample illustrated in FIG. 1, and a view illustrating a relationship between the sample and image pickup areas in an image sensor in the image pickup apparatus according to the first embodiment.

FIGS. 6A to 6K are views illustrating a relationship between an in-focus area and an image pickup area for each stage height according to the first embodiment.

FIG. 7 is an optical path diagram of an image pickup system according to second and fourth embodiments of the present invention.

FIG. 8 is a flowchart of an image pickup method executed by a computer illustrated in FIG. 7 according to the second embodiment.

FIGS. 9A to 9D are views illustrating a relationship between a sample image and an array of the image sensors according to the second embodiment.

FIGS. 10A and 10B are views for explaining an effect of S21 illustrated in FIG. 8 according to the second embodiment.

FIGS. 11A to 11Y are views illustrating a relationship between the in-focus area and the image pickup area for each position of the stage illustrated in FIG. 7 according to the second embodiment.

FIGS. 12A to 12E are views illustrating a relationship between the entire sample image and the image pickup area for each position of the stage illustrated in FIG. 7 according to the second embodiment.

FIG. 13 is an optical path diagram of an image pickup system according to a third embodiment of the present invention.

FIG. 14 is a flowchart of an image pickup method executed by a computer illustrated in FIG. 13 according to the third embodiment.

FIG. 15 is a flowchart of an image pickup method executed by the computer illustrated in FIG. 7 according to the fourth embodiment.

FIGS. 16A to 16E are views illustrating a relationship between the in-focus area and the image pickup area for each position of the stage illustrated in FIG. 7 according to the fourth embodiment.

FIGS. 17A and 17B are views for explaining an image pickup area of the fourth embodiment compared with an image pickup area illustrated in FIG. 12A.

### DESCRIPTION OF THE EMBODIMENTS

An image pickup apparatus according to this embodiment includes a controller configured to control an image pickup unit that captures an image of a sample (object) via an imaging optical system. The controller sets, based on a first image pickup area corresponding to an image pickup plane of the image pickup unit, a second image pickup area that contains the entire object, on a plurality of sections perpendicular to an optical axis of the imaging optical system, and controls the image pickup unit so as to capture an in-focus range of the object in the second image pickup area. This configuration refrains from capturing an image of a defocus range of the sample and thus can restrain a data amount, an image acquisition time, and a display load.

Herein, the in-focus range of the sample contains part of the sample imaged on an image pickup plane and part imaged in a permissible range useful for diagnosis although it is not imaged on the image pickup plane. The image pickup plane of the image pickup unit means an image pickup plane of an image sensor when the image pickup unit includes only that image sensor and all image pickup planes of a plurality of image sensors when the image pickup unit includes these image sensors.

For example, the controller instructs the image pickup unit to capture the sample so as to generate image data for synthesis at one or more positions in a direction perpendicular to the optical axis of the imaging optical system and at a plurality of positions of the imaging optical system in the optical axis direction.

The controller sets the second image pickup area by arranging one or more first image pickup areas of the image sensor in the direction perpendicular to the optical axis. The controller sets the second image pickup area so as to contain the entire sample in the direction perpendicular to the optical axis and to include part of the sample in each first image pickup area set in the second image pickup area. The second image pickup area is the very first image pickup area when the sample is smaller than the first image pickup area. The second image pickup area is an array of the first image pickup areas which contains the entire sample, when the sample is larger than the first image pickup area. This configuration can restrain a data amount, an image acquisition time, and a display load due to the image pickup of part in which the sample does not exist in a direction perpendicular to the optical axis.

Next, the controller instructs an image sensor to capture an image at a plurality of positions in the optical axis direction in each first image pickup area set in the second image pickup area, when at least part of the sample is focused on the image pickup plane to an extent useful for the diagnosis (in a predetermined range from the imaging position). However, the controller does not make an image sensor capture an image when at least part of the sample is focused on the image pickup plane to an extent useful for the diagnosis (beyond a predetermined range from the imaging position). This configuration does not capture an image of an area in which the sample does not exist in the direction perpendicular to the optical axis and thus can restrain a data amount, an image acquisition time, a display load, etc.

Next, the controller instructs the image sensor to capture an image in each first image pickup area set in the second image pickup area at a plurality of positions in the optical axis direction, when at least part of the sample is focused on the image pickup plane to the extent useful for the diagnosis (or in a predetermined range from the imaging position). On the other hand, the controller prohibits the image sensor from capturing an image when it is not focused on the image pickup plane to the extent useful for the diagnosis (or outside the predetermined range from the imaging position). This configuration does not capture a defocus sample that is useless for the diagnosis, and thus can restrain a data amount, an image acquisition time, a display load, etc. For a purpose other than generating image data for synthesis, e.g., for a focus detection, the controller may instruct the image sensor to provide a photoelectric conversion even when the sample does not have part that is imaged on the image pickup plane of the image sensor.

An image synthesizer configured to synthesize a plurality of sample images may be provided to the image pickup apparatus, or may synthesize images outside the image pickup apparatus. Image information useful for the diagnosis contains a range necessary for disease diagnosis, a range in which a cellular shape can be confirmed, a range of a cellular thickness, a range of ±1 μm from the focus position, a range in a depth of focus, etc.

Referring now to the accompanying drawings, a description will be given of a variety of embodiments according to the present invention.

### First Embodiment

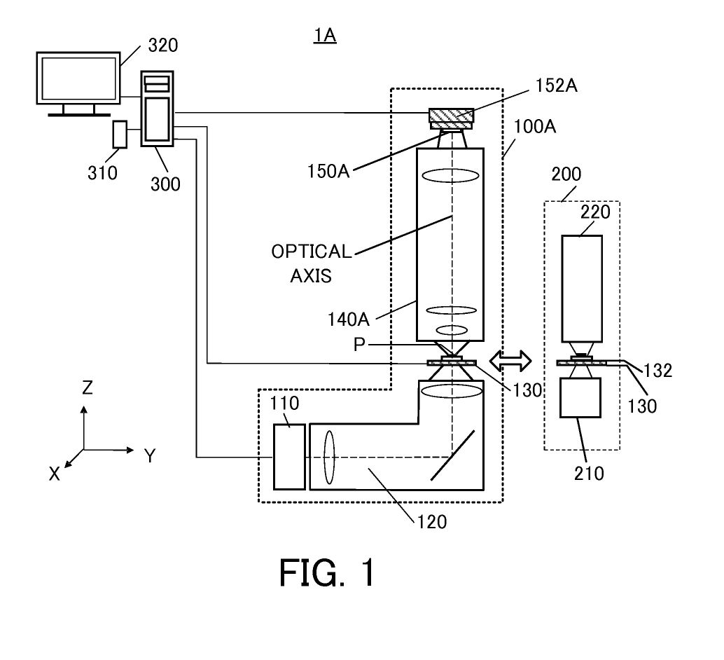

FIG. 1 is an optical path diagram of an image pickup system 1A according to a first embodiment. The image pickup system 1A uses a transmission type microscope, and includes an image pickup apparatus 100A, a (first) measurement unit 200, and a control system. The control system is used commonly for both the image pickup apparatus 100A and the measurement unit 200, and constitutes part of each the image pickup apparatus and the measurement unit.

In FIG. 1, a Z axis is set in an optical axis direction perpendicular to an image plane of an image sensor 150A, which will be described later, and an image pickup plane of an unillustrated image sensor in the image pickup unit 220. A Y axis is set in a moving direction of the stage 130 between the image pickup apparatus 100A and the measurement unit 200. An X axis is set in a direction perpendicular to the Y axis and the Z axis.

The image pickup apparatus 100A captures an image of the sample P, and includes a light source unit 110, an illumination optical system 120, the stage 130, and an imaging optical system 140A, and an image sensor 150A.

The light source unit 110 may be a lamp or a laser configured to emit visible light, such as one having a wavelength from 400 nm to 700 nm.

The illumination optical system 120 illuminates a sample (specimen) held by the stage 130 using the light from the light source unit 110. While this embodiment illuminates the sample P from the bottom, the sample P may be illuminated from the top.

The stage 130 has a holder 132 configured to hold the sample P. In FIG. 1, the stage 130 is movable between the image pickup apparatus 100A and the measurement unit 200, in each of the X axis direction and the Y axis direction, and movable in the optical axis direction (the Z axis direction illustrated in FIG. 1). The stage 130 may be movable around each of the X, Y, and Z axes by an unillustrated driver. The computer 300 controls driving of the driver for the stage 130.

This embodiment holds a sample P in form of a prepared slide, but the present invention is not limited to this embodiment as long as the sample is an object to be observed. The prepared slide includes a sample P and a medium on a rectangular slide glass having a size of 1 cm (length) and 5 cm (width), which is covered with a cover glass having a square size of 1 cm.

The imaging optical system 140A forms an image of the sample P on the image pickup plane of the image sensor 150A. The imaging optical system 140A is an objective lens configured to form an image of the sample P.

The image sensor 150A is a CCD sensor, CMOS sensor, etc. configured to photoelectrically convert an image formed by the imaging optical system 140A, and constitutes the image pickup unit. As described later, the number of image sensors in the image pickup unit is not limited. An A/D converter configured to convert an analogue signal output from the image sensor 150A into a digital signal is mounted on a substrate 152A. The substrate 152A outputs the digital signal (image data) to the computer 300. While the resolution of the image sensor 150A is higher than that of an image sensor in the image pickup unit 220, an image pickup area of the image sensor 150A is smaller. The computer 300 controls capturing by the image sensor 150A.

This embodiment fixes the imaging optical system 140A and the image sensor 150A, moves the stage 130, and thereby captures the sample P with the image pickup area in the XY plane.

The measurement unit 200 measures a position (and consequently size and shape) of the sample P in the direction perpendicular to the Z axis (as the optical axis of the imaging optical system 140A), and includes an unillustrated light source unit, an illumination optical system 210, and the image pickup unit 220. The unilluminated light source unit radiates a light flux, and includes one or more halogen lamp(s), xenon lamp(s), LD(s), LED(s), etc. The illumination optical system 210 illuminates the sample P with light from the light source unit. The image pickup unit 220 includes an image sensor configured to capture an image of the sample P illuminated by the illumination optical system 210, and an A/D converter configured to convert an analogue electric signal output from the image sensor into a digital signal. The A/D converter outputs the digital signal (image data) to the computer 300. The image pickup unit 220 may have an imaging optical system. As described above, the resolution of the unillustrated image sensor of the image pickup unit 220 has a resolution lower than that of the image sensor 150A, but a wider image pickup range.

The control system includes the computer 300, a memory (storage unit) 310, a display unit 320, an unillustrated input unit or a pointing device, such as a keyboard and a mouse. The control system may be incorporated into the image pickup apparatus 100A or the measurement unit 200 or may be configured as a separate device connected to them. Alternatively, the control system may be a server (or cloud computing) connected via a network, such as a LAN and the Internet.

The computer 300 serves as a controller configured to control each component of the image pickup apparatus 100A and the measurement unit 200. For example, the computer 300 controls, based on the measurement result of the measurement unit 200, driving of the sample P by (the unillustrated driver in) the stage 130 in the Z axis direction, and in each of the X axis direction and the Y axis direction, as well as controlling image pickup by the image sensor 150A.

The computer 300 serves as an image processor configured to obtain image data from the image sensor 150A in the image pickup apparatus 100A and the image pickup unit 220 in the measurement unit 200, and to provide predetermined processing, such as white balance and y processing, to the image data. For example, the computer 300 prepares image data of the entire sample by connecting images on the XY plane perpendicular to the Z axis direction at the same position in the Z axis direction (or optical axis direction). This processing is performed for each different position in the Z axis direction so as to connect images of the sample P at a plurality of positions in the Z axis direction for diagnosis. The image processor may be configured as a dedicated image processing apparatus, and connected to the computer 300.

The computer 300 also serves as a contrast type focus detector (contrast AF unit). The focus detector may be configured as a dedicated focus detector and connected to the computer 300. The contrast AF unit is one type of focus detection which detects a contrast peak position of an object image formed by the image sensor 150A through scanning that changes a focus position formed by the imaging optical system 140A relative to the image sensor 150A. The contrast signal is generated by integrating a high frequency component that is picked up by introducing a plurality of specific area components of a brightness signal from the image processor into a high-pass filter. However, the focus detecting method is not limited to a contrast peak detecting method, and another focus position detecting method may be used, such as one which detects a focus position as a Z position having the largest change by calculating through the Brenner differentiation changes of brightness values of different images in the Z axis direction.

The computer 300 includes an unillustrated communication unit configured to send and receive data necessary for the remote doctor, medical inspection worker, and patient via a network, such as the Internet.

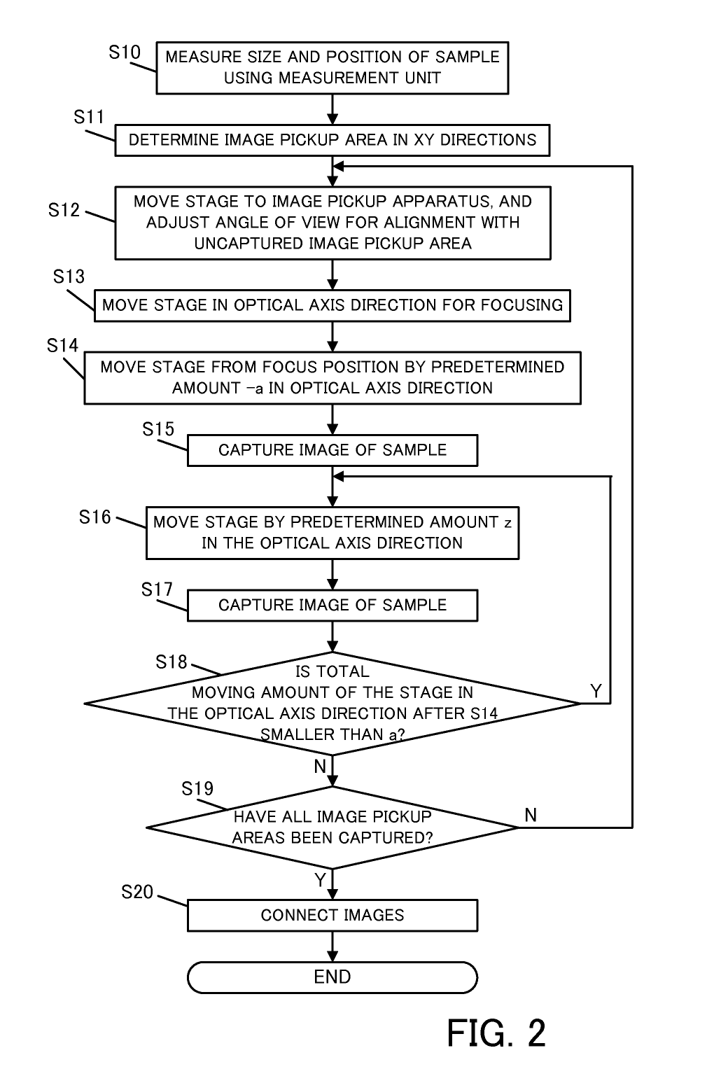

The memory 310 stores a program that enables the computer 300 to execute the image pickup method illustrated in FIG. 2, etc., another method executed by the computer 300, necessary data, and data obtained by the image pickup apparatus 100A and measurement unit 200, etc. The memory 310 includes a ROM, a RAM, a hard disc drive, an optical disc, etc. The memory 310 may be built in the computer 300, or arranged on the network. The display 320 is a display unit configured to display a processed image for diagnosis, and may be a liquid crystal display.

FIG. 2 is a flowchart of the image pickup method executed by the computer 300, and “S” stands for the step, “Y” stands for “Yes,” “N” stands for “No.” These definitions are applied to other flowcharts. In addition, the flowcharts in FIG. 2 and other figures can be implemented as a program that enables a computer to execute each step. This program is stored in the memory 310 in this embodiment, but may be stored in a recording medium, such as a non-transitory computer readable medium.

Initially, the computer 300 instructs the measurement unit 200 to measure the position (consequently the size and shape) of the sample P on the XY plane (S10), obtains the measurement result from the measurement unit 200, and determines the image pickup area on the XY plane based on it (S11). The computer 300 stores information of the determined image pickup area in the memory 310. More specifically, in S11, the computer 300 sets the second image pickup area in the direction perpendicular to the Z axis direction, which is formed by arranging one or more of the (first) image pickup areas of the image sensor 150A. In that case, the computer 300 sets the second image pickup area so that the second image pickup area contains the entire sample P in the direction perpendicular to the Z axis direction and so that each first image pickup area set in the second image pickup area contains part of the sample P.

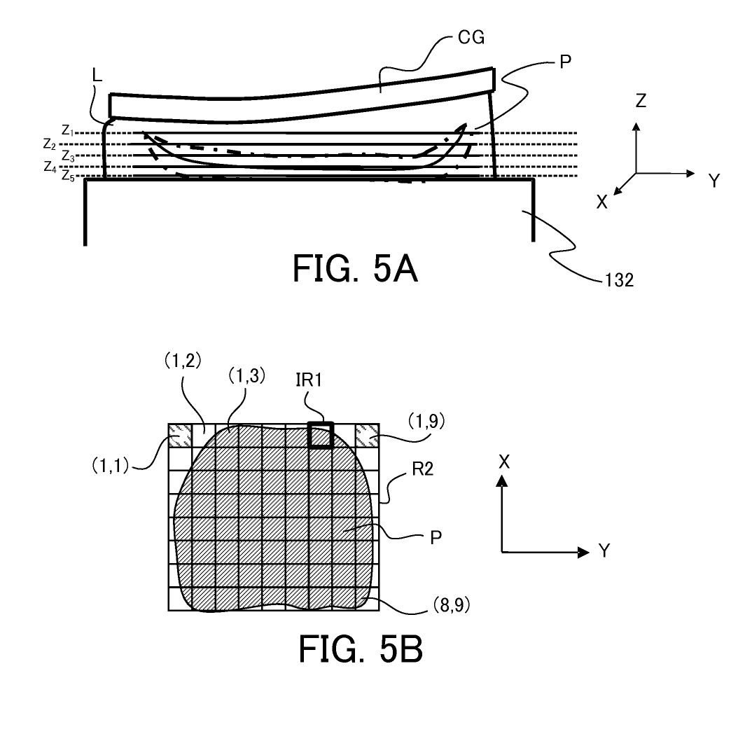

For example, in S10, the computer 300 obtains information of the position, the size, and the shape of the sample P as illustrated in FIG. 5B. IR1 is a square area enclosed by a thick line and represents the first image pickup area that is an image pickup area for one image pickup operation of the image sensor 150A. At this time, the computer 300 determines an image pickup area R2 (second image pickup area) in S11, by removing an area (1, 1) at the upper left corner and an area (1, 9) at the upper right corner, in each of which the sample P does not exist, from the 8×9 matrix area of the area IR1 that encloses the entire sample P. The computer 300 can reduce a data amount to be stored, by removing the areas (1, 1) and (1, 9) from the image pickup area R2.

Next, the computer 300 controls the stage 130 and adjusts the angle of view for an alignment with the uncaptured image pickup area (S12). For example, the computer 300 aligns the image pickup area IR1 with the area (1, 2) in FIG. 5B.

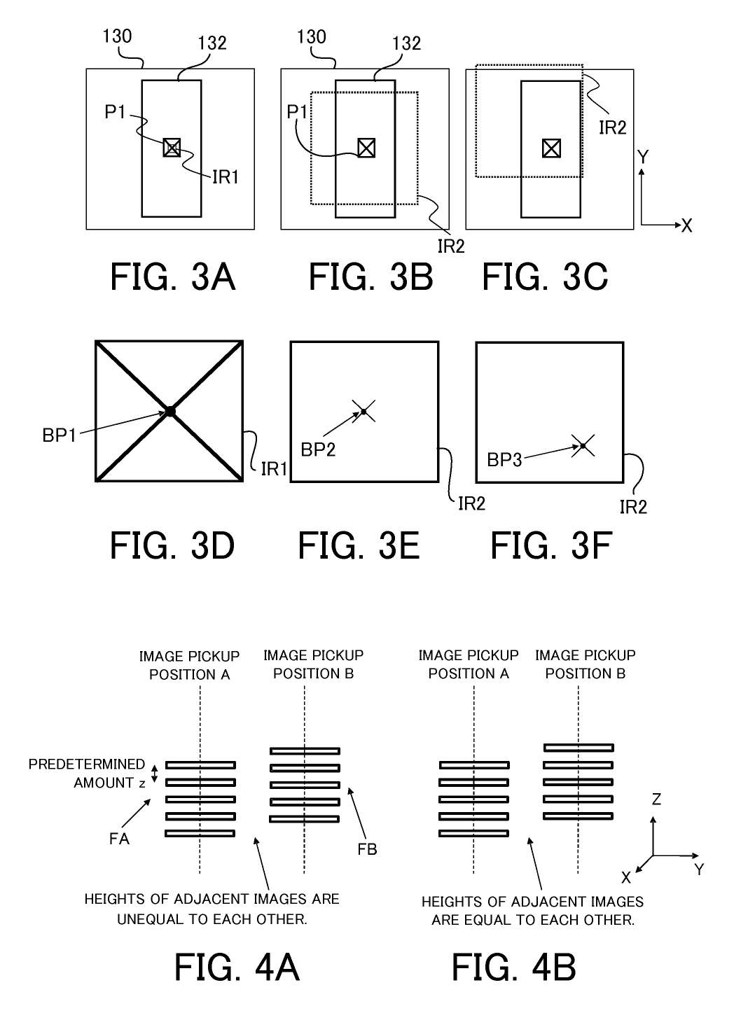

In moving the stage 130 between the image pickup area 100A and the measurement unit 200, a shift associated with driving may be corrected. FIGS. 3A to 3F are views for explaining a method for correcting the shift associated with driving the stage 130 in S12.

Initially, in the assembly, a reference mark P1 for a position calibration is used to obtain a coordinate BP1 of a reference position (center position) of the reference mark P1 of the image sensor 150A and a coordinate BP2 of the reference position (center position) of the reference mark P1 of the image sensor of the image pickup unit 220.

FIG. 3A is a plane view illustrating a relationship between the reference mark P1 and the image pickup range IR1 when the reference mark is mounted onto the holder 132 of the stage 130 so that the center of the reference mark P1 is aligned with the optical axis center of the imaging optical system 140A. FIG. 3B is a plane view illustrating an ideal relationship between the reference mark P1 and an image pickup range IR2 in the image pickup apparatus 200 when the stage 130 is moved from the image pickup apparatus 100A to the measurement unit 200.

FIG. 3D is a view illustrating that BP1 is located at the image center of the image pickup range IR1. FIG. 3E is a view illustrating that BP2 is located at the center of the image pickup range IR2. It is thus ideal that even when the stage 130 moves, the object located at the coordinate BP1 set at the center of the image pickup range IR1 is maintained as the object located at the coordinate BP2 as the center of the image sensor IR2.

However, due to assembly tolerance in the actual configuration, the object projected onto the coordinate BP1 may shift from the optical axis center of the image pickup unit 220 as illustrated in FIG. 3C, and may be captured at a coordinate BP3 illustrated in FIG. 3F different from the coordinate BP2. In S12, the computer 300 moves the sample P from the measurement unit 200 to the image pickup unit 100A so as to correct a shift between the coordinate BP2 and the coordinate BP3, and determines an image pickup range in the Z axis direction with the image pickup apparatus 100A.

An image pickup range that is deemed necessary for a pathologist to view shape information has been previously set in the computer 300 via the unillustrated input unit. For example, the imaging optical system 140A is an optical system having a fixed NA, and its depth of focus is represented as λ/NA² and now it is assumed that an image pickup range of 5 times as long as the depth of focus is set.

Next, the computer 300 moves the stage 130 in the Z axis direction, detects an in-focus position by the above contrast type focus detection (S13), and stores the in-focus position in the memory 310. At this time, the computer 300 obtains shape information of the sample P in the focus detection, as illustrated by an alternate long and short dash line in FIG. 5A.

Next, the computer 300 moves the stage 130 from the focus position by 2λ/NA², which is half a first amount a, in the −Z axis direction opposite to the +Z direction (S14), and captures an image of the sample P using the image sensor 150A (S15). In S14, for example, the computer 300 moves the stage 130 to the lowest rectangle position, when the in-focus position in the Z axis direction is a center position FA at an image pickup position A on a certain XY coordinate illustrated on the left side in FIG. 4A. The first amount a is an interval between two image pickup positions that are farthest from each other in the plurality of image pickup positions in the optical axis direction, and it is an interval between the top rectangle position and the bottom rectangle position in FIG. 4A. In FIGS. 4A and 4B, each elongated rectangle schematically illustrates the position of the sample P, and the interval between two adjacent positions is λ/NA². The broken line represents the optical axis. Alternatively, the computer 300 moves the stage 130 to a position Z₅ when the in-focus position is a position Z₃ illustrated by the solid line in the example illustrated in FIG. 5A.

Next, the computer 300 drives the stage 130 in the +Z axis direction (S16) from that position by a second amount b of λ/NA², and captures an image of the sample P with the image sensor 150A (S17). The second amount b is an interval between two adjacent image pickup positions among the plurality of image pickup positions in the optical axis direction. An absolute value of the amount b as the interval in two adjacent positions in the optical axis direction may be a value equal to or lower than the depth of focus. In S16, for example, the computer 300 moves the stage 130 from the bottom rectangle position to the rectangle position just above the bottom rectangle position in FIG. 4A.

Next, the computer 300 determines whether a total moving amount of the stage 130 after S14 in the Z axis direction is smaller than the first amount a (S18). When the computer 300 determines that the total moving amount of the stage 130 in the Z axis direction is smaller than the first amount a (Y of S18), the flow returns to S16. As a result, for example, the stage 130 is moved to the top rectangle position in FIG. 4A so as to capture an image of the sample P.

When the computer 300 determines that the total moving amount of the stage 130 after S14 in the Z axis direction is equal to or larger than the first amount a (N of S18), the computer 300 determines whether all image pickup areas have already been captured (S19). When the computer 300 determines that there is an uncaptured image pickup area (N of S19), the flow returns to S12. For example, the computer 300 stepwise feeds the stage 130 to the area (1, 3) in FIG. 5B for similar processing. The computer 300 moves the stage 130 in the XY directions perpendicular to the Z axis direction in accordance with the image pickup range determined by the measurement unit 200 by considering the image connections.

In the following S13, similar to the above, while the stage 130 is being moved in the Z axis direction, the stage height position is measured and determined which provides the highest contrast of the image taken by the image sensor 150A. The position of the stage 130 at this time may be the same focus position in the XY position used for the previous image pickup, if the stage height difference is within the depth of focus of λ/NA² (FIG. 4A). Alternatively, when the stage height difference from the XY position used for the previous image pickup is equal to or larger than the depth of focus of λ/NA² (FIG. 4B), the closest position may be selected among discrete positions spaced every λ/NA².

FIGS. 4A and 4B illustrate positions of adjacent images in the Z axis direction when images are captured five times at the image pickup position A in the Z axis direction, the stage is stepped to the image pickup position B, and images are captured five times at the image pickup position B. For example, the image pickup position A corresponds to the center position of the area (1, 2) illustrated in FIG. 5B, and the image pickup position B corresponds to the center position of the area (1, 3). An in-focus position FA for the image pickup position A shifts from an in-focus position FB for the image pickup position B due to the surface roughness of the sample P. In FIG. 4B, an image capturing position for the image pickup position A is aligned with that for the image pickup position B in the Z axis direction for each the predetermined amount z. In FIG. 4A, when the predetermined amount z is larger than the depth of focus, the connecting processing between adjacent images may fail, whereas the malfunction of the processing can be restrained in FIG. 4B. This operation is performed for the entire surface of the image pickup range determined by the measurement unit 200.

When the computer 300 determines that all image pickup areas have been captured (Y of S19), for example by detecting that the image pickup of the area (8, 9) in FIG. 5B has been captured, the computer 300 synthesizes images by connecting them (S20). In synthesizing the images in S20, for example, only images at the same stage height are synthesized among the images at discrete stage heights every λ/NA². The computer 300 moves the stage 130 from the initial image pickup position by 4·λ/NA². As a result, the computer 300 obtains the images every unit of the depth of focus in a range that is 5 times as long as the depth of focus of λ/NA² from −2·λ/NA² to 2·λ/NA². Thereafter, the computer 300 ends the processing.

FIG. 5A is a schematic sectional view on the YZ section of the sample P held by the holder 132 of the stage 130. CG denotes a cover glass, and L denotes liquid. A boat shape illustrated by an alternate long and short dash line represents the body of the sample P, and this shape can be obtained by connecting points at which the contrast becomes almost zero. The solid line represents a focus position (contrast peak position) of the sample P obtained by the contrast type focus detection.

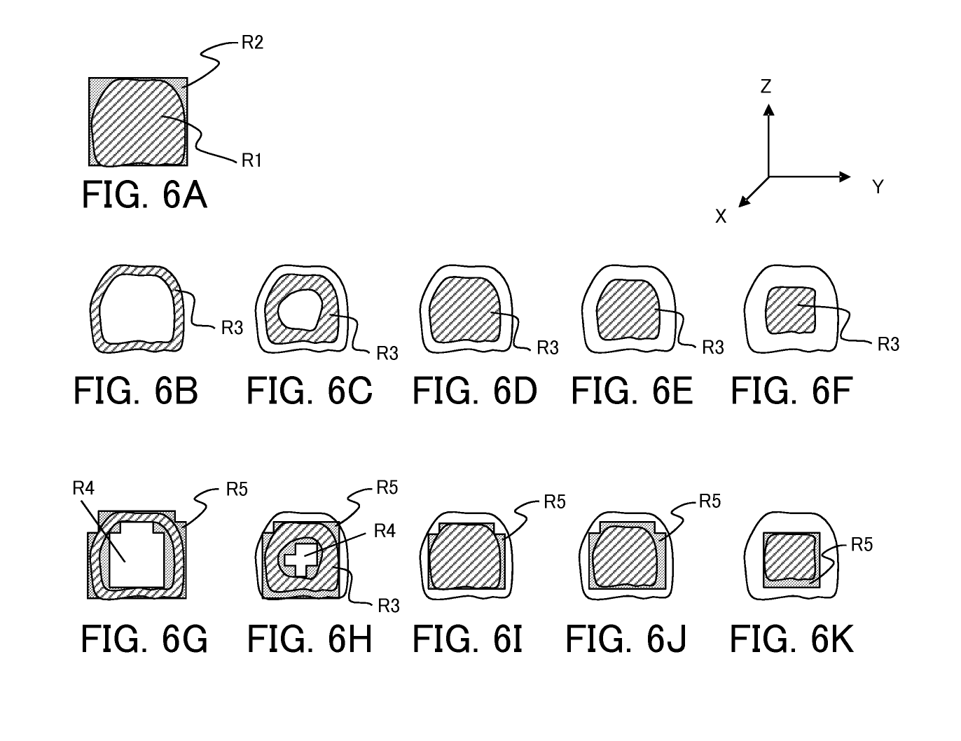

The stage 130 is moved in the optical axis direction so that the object plane of the imaging optical system 140A located at each of the positions Z₁ to Z₅. The conventional method does not remove the areas (1, 1) and (1, 9) illustrated in FIG. 5B from the area R2, and captures images at each of the positions Z₁ to Z₅ as long as the sample P is located on the optical axis. Hence, the conventional method obtains an image illustrated in FIG. 6A irrespective of the position of the stage 130 in the Z axis direction.

On the other hand, the method according to this embodiment uses the image pickup area R2 that does not contain the areas (1, 1) and (1, 9), reducing the data amount. In addition, in S15 and S17, the computer 300 selects the image sensor 150A used to capture an image at a plurality of image pickup positions Z₅ to Z₁ in the Z axis direction for each first image pickup area IR1 in the second image pickup area R2. The computer 300 allows the image sensor 150A to capture an image when at least part of the sample P is imaged on the image pickup plane to the extent useful for the diagnosis, but the computer 300 prohibits the image sensor 150B from capturing the image when the sample P is defocused to the extent useless for the diagnosis. In moving the stage 130 so that the object plane of the imaging optical system 140A is located at each of the positions Z₁ to Z₅, no image is captured at each position of the stage 130 in the Z axis direction, when the sample P is located on the optical axis but so defocused that the image is useless for the diagnosis.

FIG. 6B illustrates an image taken by the image sensor 150A when the stage 130 is moved so that the object plane of the imaging optical system 140A is located at the position Z. An area R3 is focused at the position Z₁ and it is unnecessary to capture an image of a white area inside the area R3 illustrated in FIG. 6B. However, due to the square shape of the first image pickup area IR1 illustrated in FIG. 5B, the computer 300 determines that a gray area R5 containing the area R3 and excluding a white area R4 in FIG. 6G may be captured.

Similarly, FIG. 6C illustrates an image taken by the image sensor 150A when the stage 130 is moved so that the object plane of the imaging optical system 140A is located at the position Z₂. In this case, the computer 300 determines that a gray area R5 containing the area R3 and excluding a white area R4 in FIG. 6H may be captured. FIGS. 6D to 6F illustrate images taken by the image sensor 150A when the stage 130 is moved so that the object plane of the imaging optical system 140A is located at each of the position Z₃ to Z₅. In this case, the computer 300 determines that the area R5 in FIGS. 61 to 6K may be captured.

In either case, the area R5 is narrower than the area R1, and thus the image synthesizing load lessens and the image pickup number reduces. As illustrated in FIGS. 6G and 6H, data may be provisionally generated and synthesized for a smaller data amount in the image generation or for the image data compression, when there is no image pickup information at a stage height corresponding to a certain stage position on the XY plane. Even in this case, as illustrated in FIG. 6A, the image data size becomes smaller than that generated by capturing images at all positions in the Z axis direction.

For better understanding, this embodiment captures five images of the sample P in the Z-axis direction, as illustrated in FIG. 4, but the image pickup number is not limited to five. The computer 300 obtains information of a solid line and an alternate long and short dash line in FIG. 5 in S13, and can determine the predetermined interval, such as an interval equal to or smaller than the depth of focus, and how many intervals need to be set based on the thickness information of the sample P.

As discussed, this embodiment obtains images at a plurality of image pickup positions of the stage 130 in the Z axis direction, and reduces the image processing load and the image pickup number. Due to a quick acquisition of the image data with a smaller data amount, the sample P can be easily estimated in the Z axis direction.

### Second Embodiment

The first embodiment uses one image sensor 150A and the imaging optical system 140A having a narrow angle of view, whereas the second embodiment uses a plurality of image sensors 150B and an imaging optical system having a wide angle of view so as to quickly capture an image of a relatively large sample P.

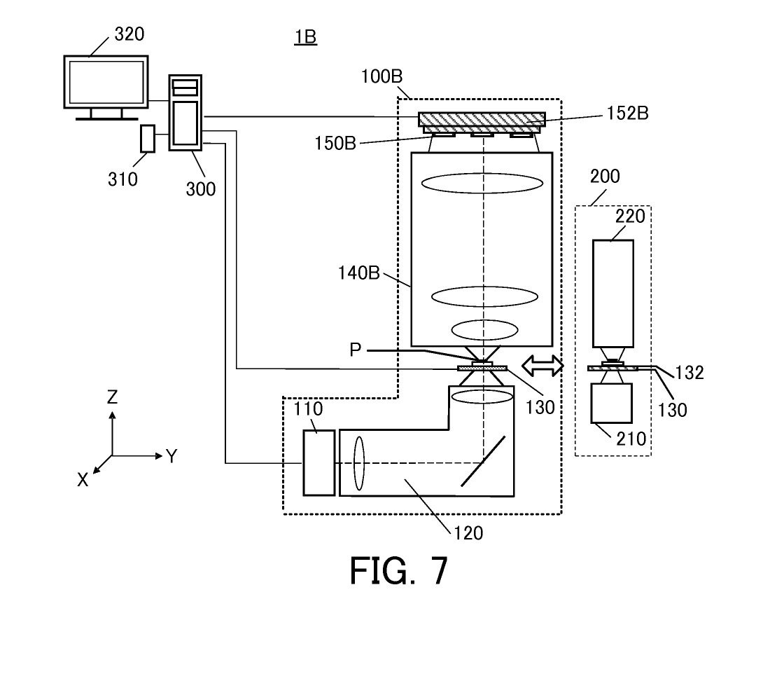

FIG. 7 is an optical path diagram of an image pickup system 1B according to the second embodiment. The image pickup system 1B uses a transmission type microscope, and includes an image pickup apparatus 100B, a measurement unit 200, and a control system. The measurement unit 200 and the control system are similar to those of the first embodiment.

The image pickup apparatus 100B captures an image of the sample P, and includes a light source unit 110, an illumination optical system 120, a stage 130, an imaging optical system 140B, and a plurality of image sensors 150B. In this embodiment, nine image sensors 150B are mounted on the common substrate 152B in a 3×3 lattice shape, and an angle of view of the imaging optical system 140B is wider than that of the imaging optical system 140A.

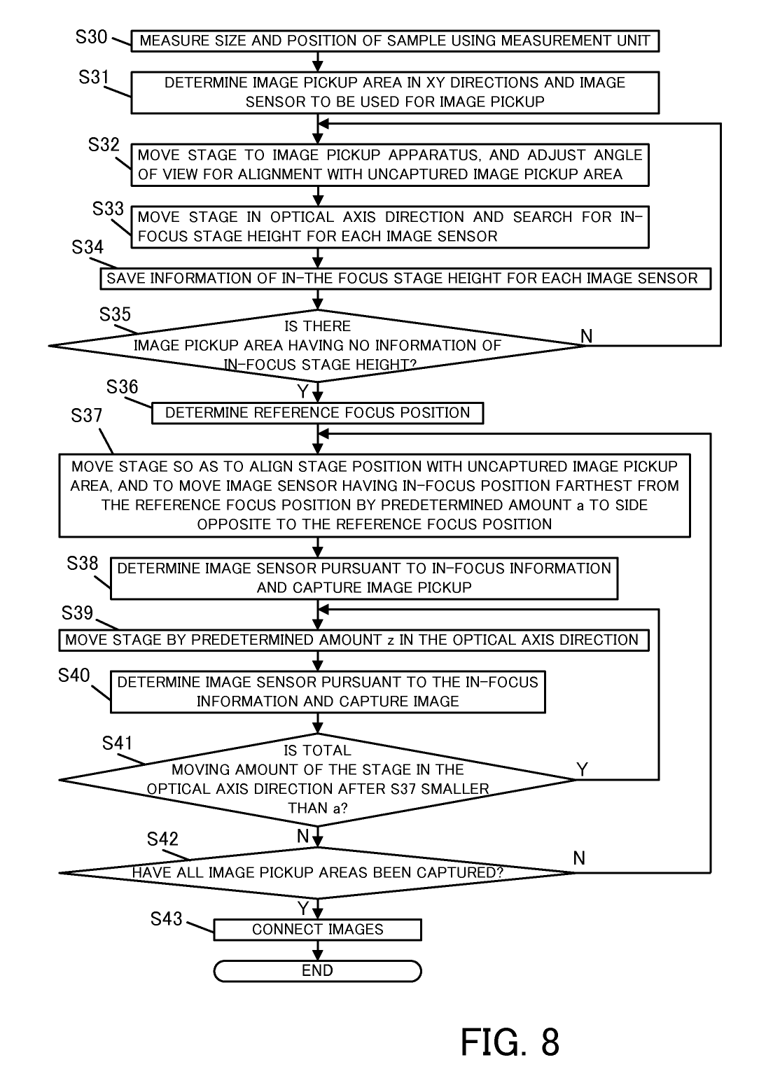

FIG. 8 is a flowchart of an image pickup method executed by the computer 300.

Initially, similar to S10, the computer 300 instructs the measurement unit 200 to measure a position (consequently the size and shape) of the sample P on the XY plane (S30), and obtains the measurement result from the measurement unit 200. Next, the computer 300 determines the image pickup area on the XY plane orthogonal to the Z axis direction of the sample P and the image sensor 150B to be used, based on the measurement result of the measurement unit 200 (S31). The determination of the image pickup area is similar to that in the first embodiment.

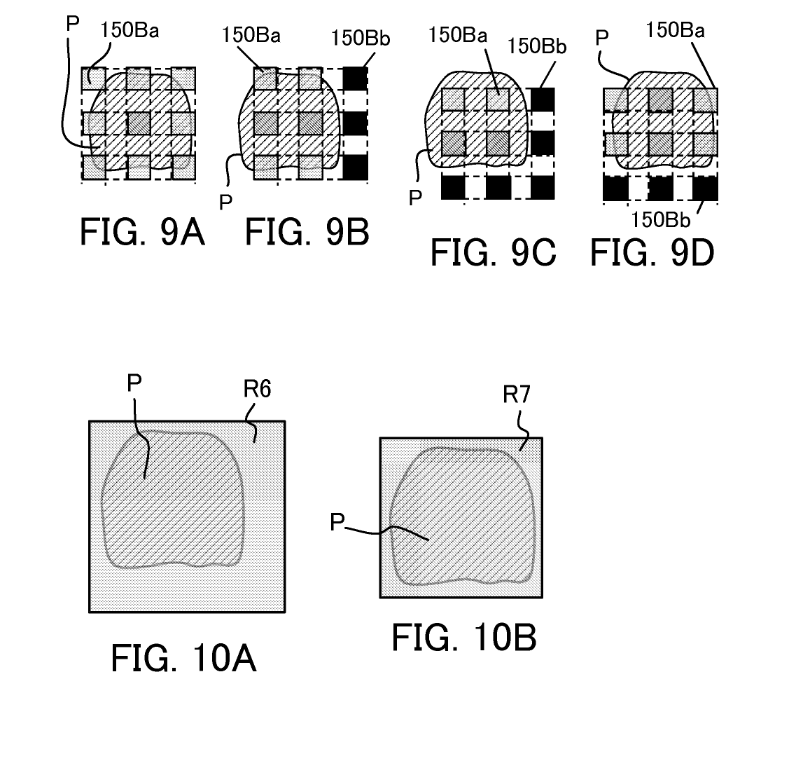

FIGS. 9A to 9D are views illustrating a positional relationship between nine image sensors 150B and the image of the sample P. The image sensors 150B include an image sensor 150Ba in which at least part of the image of the sample P is formed and an image sensor 150Bb in which no image of the sample P is formed. In S31, the computer 300 selects the image sensor(s) 150Ba.

In S31, as illustrated in FIG. 9A, the second image pickup area is determined and nine image sensors 150Ba are selected. Thereafter, in order to capture a gap among the image sensors 150Ba in FIG. 9A, the image sensors 150B and the sample P are moved relative to each other as illustrated in FIGS. 9B to 9D. In this embodiment, the sample P is stepped. In changing the image pickup position in this direction perpendicular to the optical axis, the computer 300 prohibits the image sensors 150Bb among the plurality of image sensors 150B from capturing images because the image sensors 150Bb are located outside the second image pickup area illustrated in FIG. 9A.

FIGS. 10A and 10B are views for explaining an effect of S31. FIG. 10A is a view illustrating a relationship between the image pickup area and the sample image when the computer 300 selects all the image sensors 150B illustrated in FIGS. 9A to 9D in S31. FIG. 10B is a view illustrating a relationship between the image pickup area and the sample image when the computer 300 selects the image sensors 150Ba in S31.

As a result of that the sample P is captured at each of four XY coordinates of the stage 130 illustrated in FIGS. 9A to 9D and the images are synthesized, an image pickup area R6 and the image of the sample P are illustrated in FIG. 10A. In FIGS. 9B to 9D, the computer 300 prohibits the image sensors 150Bb from capturing images because at least part of the sample image is not formed on their image pickup planes. As a result, an image pickup area R7 and the image of the sample P are illustrated in FIG. 10B, and an image data amount for storage of the image pickup area R7 is smaller than that of the image pickup area R6. The computer 300 stores information of the determined image pickup area and the selected image sensor 150B in the memory 310.

The computer moves the stage 130 to the image pickup apparatus 100B, and adjust the angle of view for alignment with the uncaptured image pickup area illustrated in FIG. 9A (S32). Next, the computer 300 moves the stage 130 in the Z axis direction and detects the in-focus position for each image sensor through the above contrast type focus detection (S33), and stores the XY coordinate and the in-focus position (Z coordinate) of the stage 130 in the memory 310 (S34).

Next, the computer 300 determines whether there is an image pickup area having no information of the in-focus position of the stage 300 in the Z axis direction or whether information of FIGS. 9A to 9D has been obtained (S35).

Assume that the computer 300 determines that there is an image pickup area having no information of the in-focus position of the stage 300 in the Z axis direction (N of S35), and controls the stage 130 so as to adjust the angle of view for alignment with the uncaptured image pickup area illustrated in FIG. 9B (S32). Next, the computer 300 moves the stage 130 in the Z axis direction, detects the in-focus position for each image sensor by performing the above contrast type focus detection (S33), and stores the XY coordinate and the in-focus position (Z coordinate) of the stage 130 in the memory 310 (S34).

After repeating the similar procedure for the image pickup areas illustrated in FIGS. 9C and 9D, the computer 300 determines that there is no image pickup area having no information of the in-focus position of the stage 300 in the Z axis direction (Y of S35).

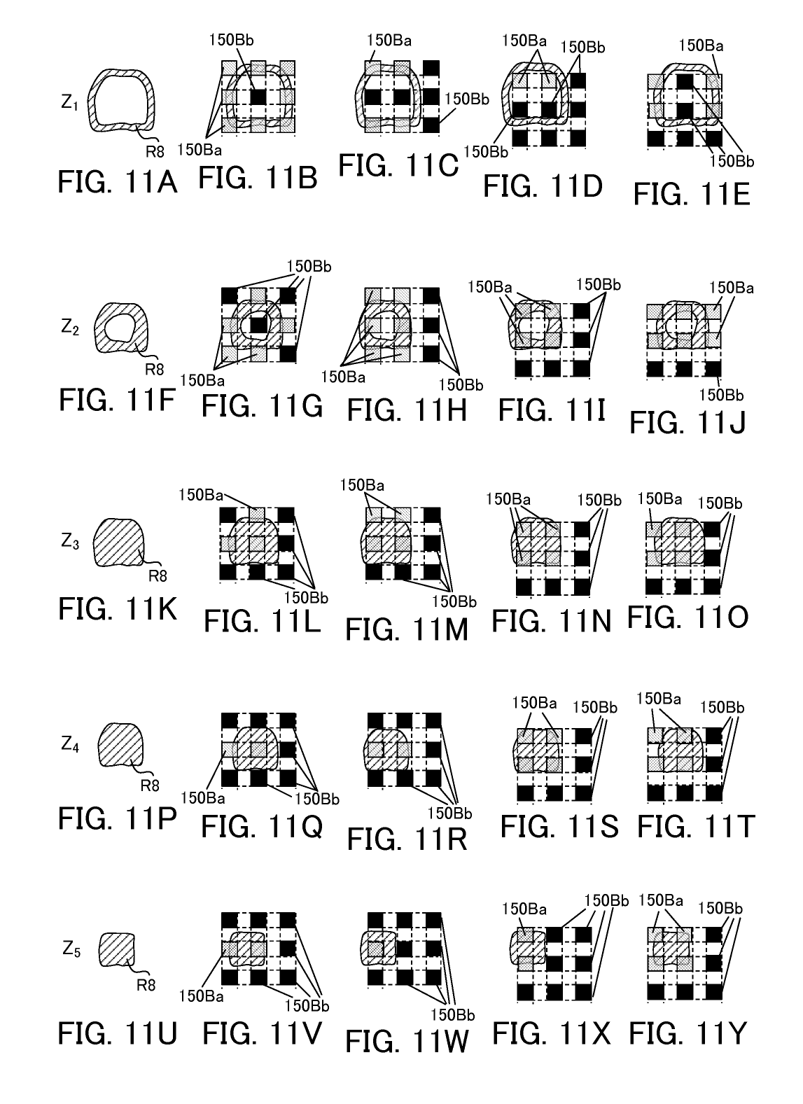

Next, the computer 300 determines a reference focus position based on the XYZ coordinate of the stage 130 so as to obtain the sample image, so that focus positions of images obtained by the plurality of image sensors 150B can be close to one another (S36). For example, the reference focus position can be calculated as a simple average position, a weighted average position, etc. of the focus positions for the plurality of image sensors. Assume that an image pickup area R8 convers a range illustrated in FIGS. 11A, 11F, 11K, 11P and 11U for each of the positions Z₁ to Z₅ illustrated in FIG. 5A.

Next, the computer 300 aligns the stage 130 with the uncaptured image pickup area (S37). At this time, the computer 300 moves the image sensor 150Ba having a focus position farthest from the reference focus position by 2λ/NA² from the reference focus position in the −Z axis direction opposite to the +Z axis direction (S37). The definitions of the first amount a and the second amount b are similar to those of the first embodiment.

Next, the computer 300 uses the information of the in-focus position and the selected image sensors 150Ba to capture the image of the sample P without using the non-selected image sensors 150Bb (S38). For example, if the position Z₃ is the reference focus position and the sample P is located at the position Z₁, eight image sensors 150Ba among the nine image sensors 150B illustrated in FIG. 11B are used to capture the image of the area R8 illustrated in FIG. 11A, and one image sensor 150Bb is not used to capture the image.

Next, the computer 300 moves the stage 130 by the second amount b of λ/NA² from that position in the +Z axis direction (S39), and captures the image of the sample P with the image sensors 150Ba selected in S36 (S40).

Next, the computer 300 determines whether the total moving amount of the stage 130 after S37 in the Z axis direction is smaller than the first amount a (S41). When the computer 300 determines that the total moving amount of the stage 130 is smaller than the first amount a (Y of S41), the flow returns to S39.

This embodiment captures the image pickup area illustrated in FIG. 11F, 11K, 11P or 11U whenever the position of the stage 130 is changed to each of the positions Z₂ to Z₅, and captures the sample P with the image sensors 150Ba illustrated in FIGS. 11G, 11L, 11Q, and 11V.

When determining that the total moving amount of the stage 130 after S37 in the Z axis direction is equal to or larger than the first amount (N of S41), the computer 300 determines whether all the image pickup areas have already been captured (S42). When the computer 300 determines that there is an uncaptured image pickup area (N of S42), the flow returns to S37 so as to capture the image of the sample P with image sensors 150Ba illustrated in FIGS. 11H, 11M, 11R, and 11W. This procedure is repeated until the sample P is captured with the image sensors 150Ba illustrated in FIGS. 11J, 11O, 11T and 11Y. The computer 300 moves the stage 130 in the XY directions perpendicular to the Z direction in accordance with the image pickup range determined by the measurement unit 200 by considering the image connections.

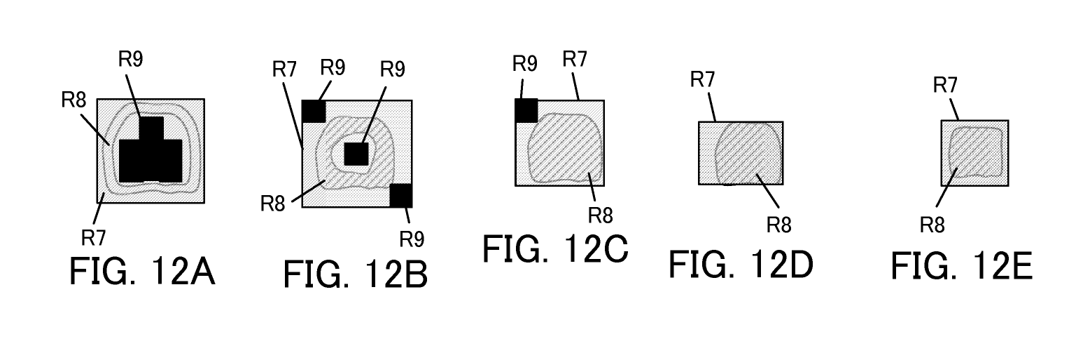

When determining that all image pickup areas have already been captured (Y of S42), the computer 300 synthesizes images by connecting them (S43). In synthesizing the images, similar to the first embodiment, for example, only images at the same stage height are synthesized among the images at discrete stage heights every predetermined amount, such as λ/NA². When there is no image pickup information at a corresponding stage height, data may be provisionally generated and synthesized for a smaller data amount in the image generation or for the image data compression. Then, the entire image of the sample can be obtained for each stage height. This embodiment obtains synthesized images at the positions Z₁ to Z₅ as illustrated in FIGS. 12A to 12E.

Since this embodiment uses the imaging optical system 140B having a wide angle of view in which a plurality of image sensors 150B can be arranged, the driving number of the stage 130 in the XY directions reduces and a sample image wider than that of the first embodiment can be quickly obtained. Since the area R7 is narrower than the area R6, the image synthesizing load lessens and the image pickup number reduces. In particular, in FIGS. 12A and 12B, the computer 300 excludes the image pickup area IR1 corresponding to an area R9, and thereby reduces the image synthesizing load and the image pickup number.

### Third Embodiment

The first and second embodiment determines the position of the stage 130 in the Z axis direction using the image pickup apparatuses 100A and 100B and the computer 300, whereas a third embodiment provides a dedicated measurement unit 250 for determining the position of the stage 130 in the Z axis direction separately from the imaging optical system 140C.

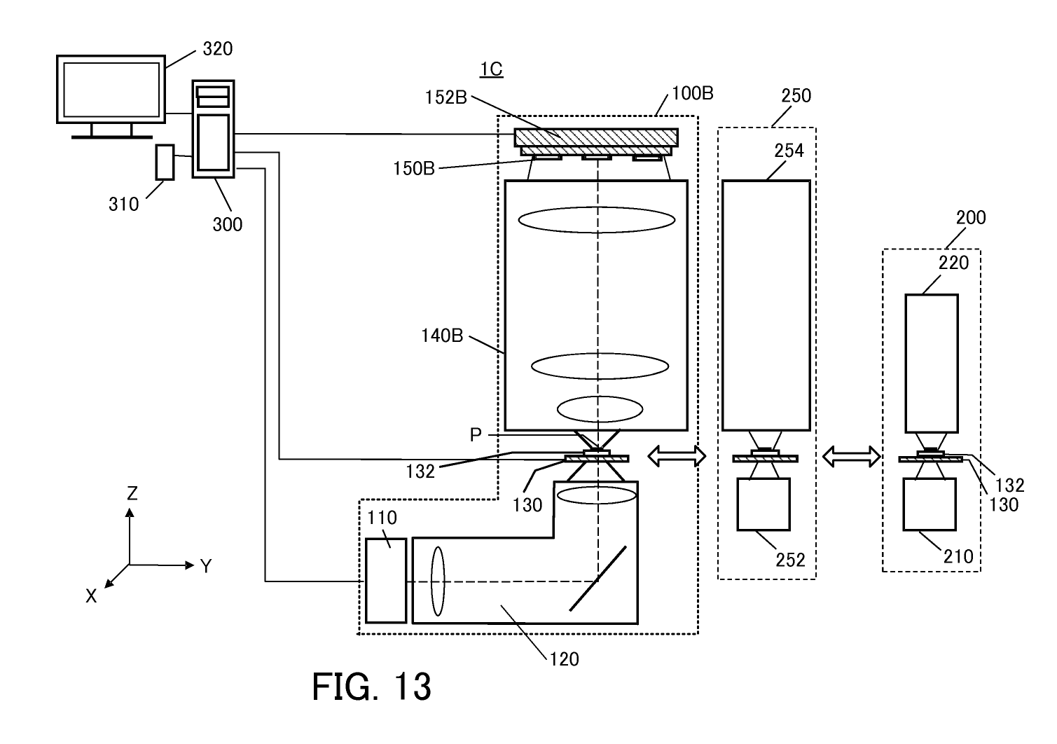

FIG. 13 is an optical path diagram of an image pickup system 1C according to the third embodiment. The image pickup system 1C uses a transmission type microscope, and includes an image pickup apparatus 100B, a (first) measurement unit 200, a dedicated (or second) measurement unit 250, and a control system. The image pickup apparatus 100B is the same as that in the second embodiment, and the measurement unit 200 and the control system are similar to those of the first embodiment.

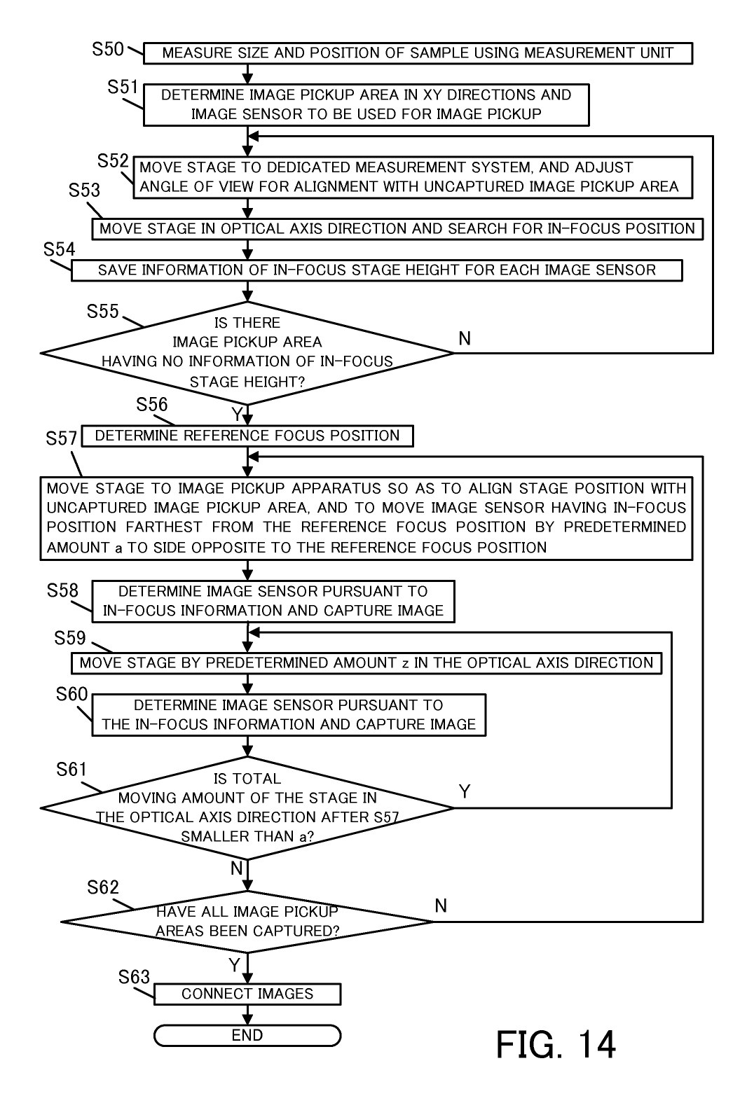

FIG. 14 is a flowchart illustrating an image pickup method executed by the computer 300. Initially, similar to S30 and S31, the computer 300 performs S50 and S51. Next, the computer 300 moves the stage 130 to the dedicated measurement unit 250 for S52 to S56, similar to S32 to S36 in FIG. 8. This embodiment is different from the second embodiment in that S52 to S56 are performed with the dedicated measurement unit 250. The dedicated measurement unit 250 provides a focus detection to detect the focus position for each first image pickup area set in the second image pickup area, and obtains the shape information of the sample P in the focus detection. Thereafter, the computer 300 moves the stage 130 to the dedicated measurement unit 250 for S57 to S63, similar to S37 to S43 illustrated in FIG. 8.

This embodiment enables parallel processing of the dedicated measurement unit 250 and the image pickup apparatus 100B. In other words, the image pickup apparatus 100B can capture an image based on the previous measurement result of the dedicated measurement unit 250 during a measurement of the dedicated measurement unit 250, and can capture a plurality of samples P effectively.

### Fourth Embodiment

The first to third embodiments provide the entire captured image, whereas the fourth embodiment captures an image by part of the image pickup area IR which has been cut for the pathologic diagnosis, when a ratio of the sample image is small in the image pickup area IR1 of the image sensor 150. This embodiment uses the image pickup system 1B according to the second embodiment illustrated in FIG. 7.

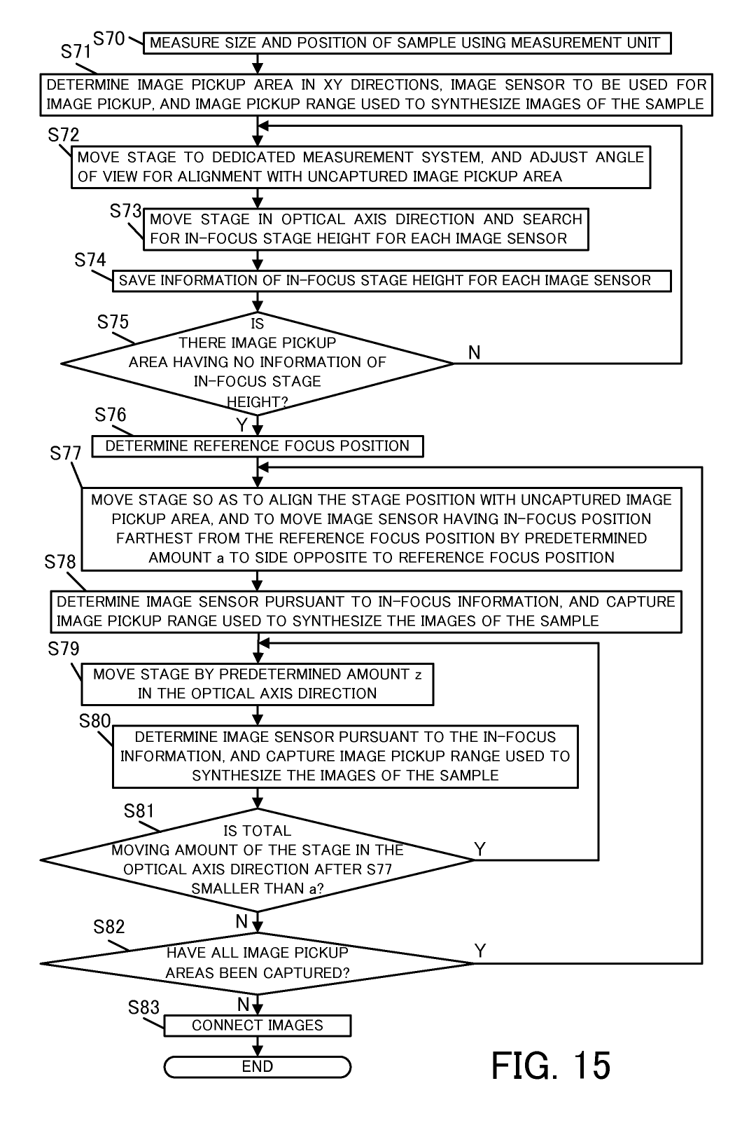

FIG. 15 is a flowchart of an image pickup method executed by the computer 300. Initially, the computer 300 performs S70 similar to S30. Next, the computer 300 determines, based on the measurement result of the measurement unit 200, the image pickup area on the XY plane orthogonal to the Z axis direction (optical axis direction) of the sample P and the image sensor(s) 150B to be used, and an image pickup range used to synthesize the sample images (S71).

Thus, this embodiment is different from the second embodiment in that this embodiment includes S71 that determines an image pickup range based on the range in which the sample image is formed within the image sensor 150B in the image pickup area determined by the measurement unit 200 so as to lessen a data amount output from the image sensor 150B.

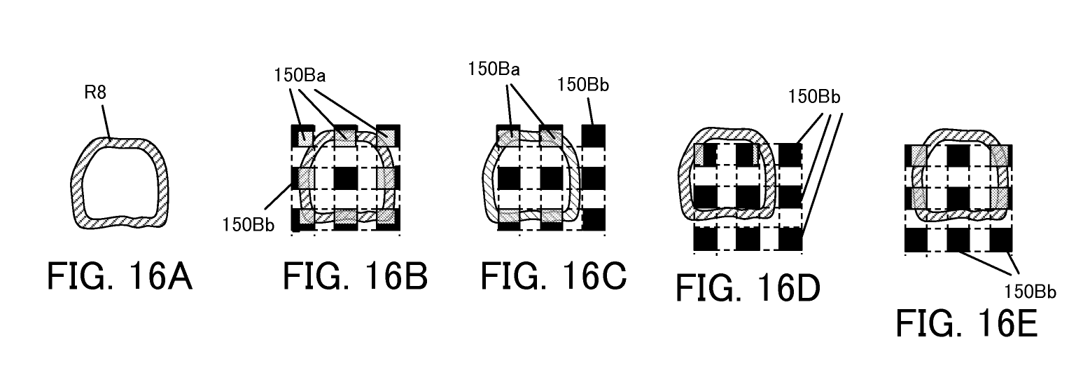

More specifically, in order to capture the area R8 of the sample P illustrated in FIGS. 11A and 16A, the image sensors 150Ba to be used are determined for each of four image pickup positions illustrated in FIGS. 16B to 16E, and an image pickup range of each image sensor 150Ba is determined. A determining method of the image sensors 150Ba to be used is similar to that applied to FIGS. 11B to 11E, but this embodiment is different in that this embodiment further determines an image pickup range for each image sensor.

The computer 300 determines a third image pickup area in which at least part of the sample P is formed, and a fourth image pickup area in which at least part of the sample P is not formed, on the image pickup plane of the image sensor in which at least part of the sample P is imaged. An image is captured in the third image pickup area, and no image is captured in the fourth image pickup area.

For example, in FIG. 16B, the computer 300 sets the third image pickup area to a gray part in which the image of the sample P is formed in the image sensor 150Ba at the upper left corner, and sets the fourth image pickup area (non-image pickup area) to a black part. Since the black part is not captured, a data amount reduces by that amount.

Next, the computer 300 performs S72 to S77 similar to S32 to S37. Next, the computer 300 uses information of the in-focus position and the selected image sensors 150Ba to capture an image of the image pickup range used to synthesize the captured images of the sample P without using the non-selected image sensor 150Bb (S78). Next, the computer 300 performs S79 similar to S39. Next, the computer 300 captures the image pickup range used to synthesize the captured images of the sample P (S80). Next, the computer 300 performs S81 to S83 similar to S41 to S43.

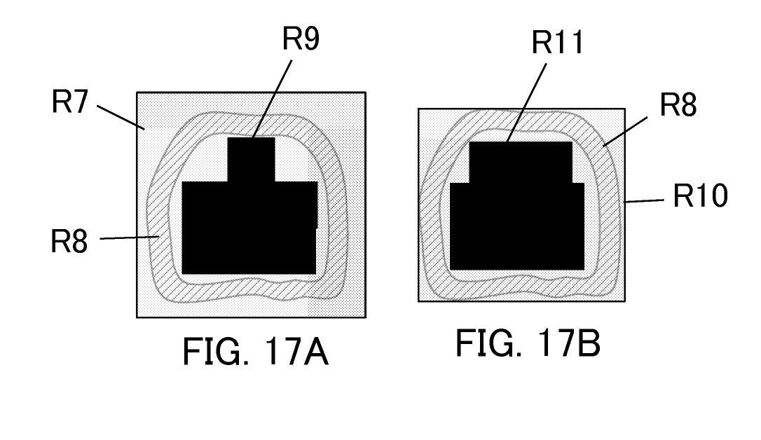

The image corresponding to the position Z₁ is the part illustrated in FIGS. 12A and 17A in the second embodiment. On the other hand, this embodiment synthesizes images in which the image pickup area has been narrowed for each image sensor 150Ba, and consequently the entire image area reduces from R7 to R10 and an internal non-image pickup area becomes larger from R9 to R11, as illustrated in FIG. 17B. This configuration can reduce a data size of the image corresponding to the position Z₁ or in its turn the entire synthesized sample.

This embodiment narrows an image pickup area in the image sensor 150Ba in accordance with the image pickup area, but the image of the sample P which has been synthesized in accordance with the procedure illustrated in FIG. 8 may be trimmed after the synthesis because this method can also reduce a data amount of the image of the entire sample reduces.

The image pickup apparatus is applicable to a field of a microscope.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. For example, each embodiment uses the transmission type optical system configured to form an image of transmission light through the sample on an image plane, but the reflection type optical system is also applicable.

Each of the above embodiment can provide an image pickup apparatus configured to quickly obtain image data of an object with a small data amount at a plurality of focus position.

This application claims the benefit of Japanese Patent Application No. 2014-091221, filed Apr. 25, 2014, which is hereby incorporated by reference herein in its entirety.

What is claimed is:

1. An image pickup apparatus comprising:
an imaging optical system configured to form an image of an object;
an image pickup unit configured to capture the image of the object via the imaging optical system; and
a controller configured to control the image pickup unit,
wherein the controller sets, so as to always include part of the object in a first image pickup area corresponding to an image pickup plane of the image pickup unit, a second image pickup area by arranging at least one first image pickup area so that the second image pickup area contains an entire object on each of a plurality of sections perpendicular to an optical axis of the imaging optical system, and controls the image pickup unit so as to capture the first image pickup area that contains an in-focus range of the object in the second image area.

2. The image pickup apparatus according to claim 1, wherein the controller sets the first image pickup area to the second image pickup area when the object is smaller than the first image pickup area, and sets an array of the first image pickup area to the second image pickup area which contains the entire object when the object is larger than the first image pickup area.

3. The image pickup apparatus according to claim 1, wherein the image pickup unit includes a plurality of image sensors, and
wherein the controller instructs one or more of the plurality of image sensors corresponding to the second image pickup range, to capture the image of the object, after the second image pickup range and the plurality of image sensors move relative to each other in the direction perpendicular to the optical axis.

4. The image pickup apparatus according to claim 1, further comprising an image synthesizer configured to synthesize a plurality of images of the object.

5. The image pickup apparatus according to claim 1, wherein the controller provides a focus detection for detecting an in-focus position in each first image pickup area set in the second image pickup area, and obtains shape information of the object in the focus detection.

6. The image pickup apparatus according to claim 1, wherein the controller determines a third image pickup area in which an image of at least part of the object is formed and a fourth image pickup area in which the image of the object is not formed, on the image pickup plane of the image pickup unit in which at least part of the object is formed, the controller allows the third image pickup area to capture the image and prohibits the fourth image pickup area from capturing the image.

7. The image pickup apparatus according to claim 1, wherein an interval between the plurality of sections in the optical axis direction is equal to or smaller than a depth of focus of the imaging optical system.

8. An image pickup system comprising:
an image pickup apparatus that includes an imaging optical system configured to form an image of an object, an image pickup unit configured to capture the image of the object via the imaging optical system, and a controller configured to control the image pickup unit, the controller setting, so as to always include part of the object in a first image pickup area corresponding to an image pickup plane of the image pickup unit, a second image pickup area by arranging at least one first image pickup area so that the second image pickup area contains an entire object on each of a plurality of sections perpendicular to an optical axis of the imaging optical system, and controls the image pickup unit so as to capture the first image pickup area that contains an in-focus range of the object in the second image area; and
a first measurement unit configured to measure a position of the object in a direction perpendicular to the optical axis direction of the imaging optical system,
wherein the controller sets the second image pickup area based on a measurement result of the first measurement unit.

9. An image pickup system comprising:
an image pickup apparatus that includes an imaging optical system configured to form an image of an object, an image pickup unit configured to capture the image of the object via the imaging optical system, and a controller configured to control the image pickup unit, the controller setting, so as to always include part of the object in a first image pickup area corresponding to an image pickup plane of the image pickup unit, a second image pickup area by arranging at least one first image pickup area so that the second image pickup area contains an entire object on each of a plurality of sections perpendicular to an optical axis of the imaging optical system, and controls the image pickup unit so as to capture the first image pickup area that contains an in-focus range of the object in the second image area;
a first measurement unit configured to measure a position of the object in a direction perpendicular to the optical axis direction of the imaging optical system; and
a second measurement unit configured to provides a focus detection for detecting an in-focus position in each first image pickup area set in the second image pickup area, and obtains shape information of the object in the focus detection,
wherein the controller sets the second image pickup area based on a measurement result of the first measurement unit, and determines whether at least part of the object is imaged on the image pickup plane of the image pickup unit based on a measurement result of the second measurement unit.

10. An image pickup method used for an image pickup apparatus that includes an imaging optical system configured to form an image of an object, and an image pickup unit configured to capture the image of the object via the imaging optical system, the image pickup method being configured to control the image pickup unit so as to capture an image of the object and to generate image data for synthesis, the image pickup method comprising the steps of:
setting, so as to always include part of the object in a first image pickup area corresponding to an image pickup plane of the image pickup unit, a second image pickup area by arranging at least one first image pickup area so that the second image pickup area contains an entire object on each of a plurality of sections perpendicular to an optical axis of the imaging optical system; and
controlling the image pickup unit so as to capture the first image pickup area that contains an in-focus range of the object in the second image area.

11. A non-transitory computer-readable medium configured to store a program that enables a computer to execute an image pickup method used for an image pickup apparatus that includes an imaging optical system configured to form an image of an object, and an image pickup unit configured to capture the image of the object via the imaging optical system, the image pickup method being configured to control the image pickup unit so as to capture an image of the object and to generate image data for synthesis, the image pickup method comprising the steps of:
setting, so as to always include part of the object in a first image pickup area corresponding to an image pickup plane of the image pickup unit, a second image pickup area by arranging at least one first image pickup area so that the second image pickup area contains an entire object on each of a plurality of sections perpendicular to an optical axis of the imaging optical system; and
controlling the image pickup unit so as to capture the first image pickup area that contains an in-focus range of the object in the second image area.
